(19) United States
(12) Patent Application Publication
(10) Pub. No.: US 2007/0141537 A1
(43) Pub. Date: Jun. 21, 2007

(54) Method for bonding dental veneers and restorations

(75) Inventors: Robert Ibsen, Santa Maria, CA (US); Lora Babir, Arroyo Grande, CA (US); William Glace, Santa Maria, CA (US)

Correspondence Address: CROWELL & MORING LLP;INTELLECTUAL PROPERTY GROUP, P.O. BOX 14300, WASHINGTON, DC, 20044-4300, US

(73) Assignee: Den-Mat Corporation

(21) Appl. No.: 11/603,102

(22) Filed: Nov. 22, 2006

Related U.S. Application Data
(60) Provisional application No. 60/739,007, filed on Nov. 23, 2005.

(51) Int. Cl. A61C 5/04

(52) U.S. Cl. 433/226

(57) ABSTRACT

The invention relates to dental composites and porcelain repair material and to methods for making and using them. In particular, the present invention is directed to dual-cure composite dental cements comprising opaquing agents.

### FIELD OF THE INVENTION

This invention relates to dental composites and porcelain repair material and to methods for making and using them.

### BACKGROUND OF THE INVENTION

Bonded porcelain veneers for aesthetic improvement of dentition have been in use for many years. These thin porcelain facings are bonded to tooth structure (either dentin or enamel) with a combination dental adhesives and composite resins. This invention relates to an improved resin for this bonding.

Over the years many composite resins have been introduced, each composite possessing certain physical properties. However, substantially all of these dental composites can be categorized into two main groups, self-cured materials and light-cured materials.

The self-cured composites have involved free radical polymerization initiated by benzoyl peroxide (or another suitable peroxide) and accelerated, typically by a tertiary amine such as N,N,dimethyl-p-toluidine. The curing agents must be stored separately from the resin they are to cure, and they are mixed together just before use.

The light-cured composites have involved free radical polymerization initiated by the photoexcitation of light-sensitive compounds by ultraviolet or visible light. They are single-component systems, typically pastes, stored in opaque containers until the time of cure. Some of the photoinitiators that have been employed are the benzoin ethers, benzil ketals, dialkoxyacetophenones, benzophenones, thioxanthones, and hydroxyalkylphenones.

In the practice of dentistry, some tooth repairs have been better achieved by self-cured composites and some have been better achieved by light-cured composites. While many factors have helped to determine whether a dentist would or should choose a self-cured material or a light-cured material, the prime factors have been working time, setting time, and the architecture of the cavity preparation.

The light-cured composites, combined with special high-lumen lighting units employing fiber optics, have offered variable working times and fast “snap” sets. Setting can take between ten and forty seconds in many instances. However, the use of light-cured composites has been limited by the depth of the repair and the ease of light penetration. Relatively unobstructed, clean, shallow repair surfaces have been required. Visible-light-cured materials have helped in solving some of the limitations caused by repair depth, by roughly doubling the depths at which cure is effective as compared to ultra-violet light-cured material. Also, many dentists have felt more comfortable using a visible, as opposed to an ultra-violet, activating light source.

The amount of cure is variable and is a function of exposure to lumens of visible light. These facts result in extremely dangerous situations in many dental restorations; because most dentists do not realize this deficiency, because light-cured systems are advertised to be able to be cured through tooth structure. In reality, the situation is, at best, a gradient level of cure obtained in relation to the amount of lumens of light energy available to the restorative resin. That is to say, layers close to the light source undergo greater percent polymerization than the underlying layers. Consequently, the incompletely polymerized restoration may wash out leak, or fail in adhesion. Yet the surface or bulk of the restoration may appear clinically adequate, even though new secondary decay may be beginning, and, because of its concealment, result in death of the pulp or loss of the tooth.

When a light-cured resin liner is used with a light-cured paste composite at a depth of around 3 mm. or greater, the resin liner may not cure because of insufficient light reaching the resin. Uncured resin liner can cause leaching, pulpal irritation, and loss of adhesion. Heretofore, the resin liner had, therefore, to be polymerized prior to placement of the composite. With this invention, such double cure is unnecessary.

Self-cured systems have offered assurance of polymerization throughout the polymer mass used in any repair surface architecture. However, their use has been limited by manufacturer-determined work times and set times. The peroxide and the accelerator could be adjusted to give widely varying setting times; the quicker the set time, the quicker the placement had to be made. Thus, in order to give enough time for accurate placement, the set times had to be longer than were desirable. Generally, set times have been at least two or three minutes after mix, and placement has had to be completed within forty-five seconds after mix. This had made dentists work somewhat faster than was desirable for many placements, and even then the patient had to be immobilized longer than was desirable before the composition set.

The composites as described above have proven valuable in methods of bonding porcelain veneers to teeth. Until recently, however, porcelain veneers have been of a thickness and opacity such that the color of the underlying tooth structure has been hidden. Recent developments have made possible much thinner veneers. These veneers made it possible to place veneers without removing tooth enamel, thus eliminating the pain and discomfort of hard tissue removal. However this allowed the underlying tooth color to be seen.

In many cases lightning of the dentition has been the main reason for the veneers. So the underlying tooth structure had to be obscured. This has traditionally been accomplished with the use of an opaquing agent such as Den-Mat's Tetrapaque. The present invention consists of a new composite cement of varying opacity, based on Ultra-Bond, composite resin cement that has been successfully utilized by dentists for over 20 years.

One embodiment of the instant invention is composite resins of various tooth shades corresponding to shades on the Vita™shade guide, utilized by a preponderance of dentists for purposes of this invention, each shade was formulated in various levels of opacity, while still faithfully reproducing the desired Vita shade.

Whereas previously the dentist would need to first opaque the tooth and/or remove excessive tooth structure or apply extra thick opaquer, then apply the cement and veneer, the invention eliminates one step, and guarantees that the opaqued veneer will match the desired shade.

### SUMMARY OF THE INVENTION

One embodiment of the invention encompasses a method of bonding porcelain veneers or restorations to a tooth without the use of an additional opaquing agent on the tooth.

Another embodiment of the invention encompasses a method lightening a tooth comprising bonding a veneer to the tooth, wherein an opaquing agent is not applied to the tooth prior to the bonding of the veneer.

Yet another embodiment of the invention encompasses composite resin cements.

A further embodiment of the invention encompasses composite resin cements comprising an opaquing agent.

Yet another embodiment of the invention encompasses composite resin cements comprising titanium dioxide as an opaquing agent.

Another embodiment of the instant invention encompasses composite resins of various tooth shades corresponding to shades on the Vita™shade guide.

A further embodiment of the instant invention encompasses a method of bonding with dual-cured cements.

### DETAILED DESCRIPTION OF THE INVENTION

For simplicity and illustrative purposes, the principles of the present invention are described by referring to various exemplary embodiments thereof Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

Until recently, porcelain veneers have been of a thickness and opacity such that the color of the underlying tooth structure has been hidden. Recent developments have made possible much thinner veneers. These veneers made it possible to place veneers without removing tooth enamel, thus eliminating the pain and discomfort of hard tissue removal. However this allowed the underlying tooth color to be seen. The present invention consists of a new composite cement of varying opacity, based on Ultra-Bond, composite resin cement that has been successfully utilized by dentists for over 20 years. Whereas previously the dentist would need to first opaque the tooth and/or remove excessive tooth structure or apply extra thick opaquer, then apply the cement and veneer, the invention eliminates one step, and guarantees that the opaqued veneer will match the desired shade. Thus, the present invention provides a novel composite resin cement comprising an opaquing agent, as well as method of making and using such composite resin cements.

The present invention further provides a method of bonding dental veneers and restoration using novel dual-cured cements. Previously, the dentist could use light-cured cements or self-cured cements. Self-cured cements suffer from short working times, but light-cured cements, if made opaque enough to hide dark tooth structure, suffer from limited depth of cure. The following examples illustrate the fact that when cured through a porcelain veneer, the light-cured cement had marginal cure depth, but dual-cured cements in accordance with the instant show greatly increased cure depth one hour later.

### EXAMPLE 1

A quantity of a typical light cured cement was irradiated with a Den-Mat Allegro curing light for 5 seconds and depth of cure measured immediately after cure utilizing Den-Mat Standard Test Method P-017, detailed hereafter:

TABLE 1
Formula A

| Component | Wt/% |
|---|---|
| PEG-400 Extended Polyurethane Dimethacrylate | 24.1252 |
| Triethylene Glycol Dimethacrylate | 6.0954 |
| Butylated Hydroxytoluene | 0.0030 |
| Ethyl 4-methylaminobenzoate | 0.0709 |
| 2,3-boranedione | 0.0669 |
| 2-(2Hydroxy-5-tert-octyphenyl)benzotriazole | 1.8144 |
| Dihydroxyethyl-P-Toluidine | 0.2421 |
| 10% Titanium Dioxide in Triethylene Glycol | 0.9058 |
| Dimethacrylate | |
| Ytterbium Phosphate | 0.1965 |
| Silanated Barium Flourosilicate Glass | 66.4797 |

TABLE 2
Formula B (opaqued)

| Component | % |
|---|---|
| PEG-400 Extended Polyurethane Dimethacrylate | 23.385 |
| Triethylene Glycol Dimethacrylate | 5.9085 |
| Butylated Hydroxytoluene | 0.0030 |
| Ethyl 4-methylaminobenzoate | 0.0701 |
| 2,3-boranedione | 0.0649 |
| 2-(2Hydroxy-5-tert-octyphenyl)benzotriazole | 1.7596 |
| Dihydroxyethyl-P-Toluidine | 0.2264 |
| Titanium Dioxide | 0.4106 |
| 10% Titanium Dioxide in Triethylene Glycol | 0.5591 |
| Dimethacrylate | |
| Ytterbium Phosphate | 0.2051 |
| Silanated Barium Flourosilicate Glass | 60.7719 |

TABLE 3
Formula C

| Component | % |
|---|---|
| PEG-400 Extended Polyurethane Dimethacrylate | 27.3789 |
| Triethylene Glycol Dimethacrylate | 6.8758 |
| Benzoyl Peroxide | 0.3938 |
| Butylated Hydroxytoluene | 0.0459 |
| Ytterbium Phosphate | 0.2193 |
| Silica Nanoparticles | 4.3213 |
| Silanated Barium Flourosilicate Glass | 60.7719 |

### EXAMPLE 1

A quantity of a typical light cured cement was irradiated with a Den-Mat Allegro curing light for 5 seconds and depth of cure measured immediately after cure utilizing Den-Mat Standard Test Method P-017:

Materials and Equipment:
1. Marathon 2000 Curing Light
2. Depth of Cure Mold
3. Small glass plate, approx 1-inch square
4. Sheet of cellophane, approx 1-inch square
5. Metric Micrometer accurate to 0.01 mm
6. Digital top loading balance
7. Composite mix pad or small plastic beaker
8. Large dental composite mix stick
9. Small dental composite mix stick
10. curing light

Method:
1. testing should be performed at 21-25° C.
2. pack material in to depth of cure mold
3. place sheet of cellophane over material followed by glass plate, press down to achieve a flat, uniform surface
4. remove the glass plate
5. place a porcelain veneer between over the sample
5. place the tip of the Marathon 2000 or Virtuoso Power Arc light pipe against the veneer on top of the material
6. turn on the light unit and expose the material being tested to the light for the required amount of time
7. after completion of exposure, carefully take the depth of cure mold apart without disturbing the sample, do not abrade the surface of the sample.

The procedure was performed with Formula A cement that had opacity increased enough to block out discolored tooth structure that might be present under a veneer. The procedure was performed and the depth of cure was measured one hour after light exposure. Results are as follows:

TABLE 1

| Sample | Depth of Cure | Depth after One Hour |
|---|---|---|
| Formula A Cement | 4.2 mm | 4.5 mm |
| Formula B Cement (opaqued) | 2.3 mm | 3.1 mm |

### EXAMPLE 2

### Example 1 was Repeated with the Following Changes

A two-part cement was employed. It was identical to the first cement of example 1 except that Part A contained enough of a free-radical initiator such as benzoyl peroxide to initiate cure without light exposure. Part B contained enough light-sensitive curatives to cause light curing when the two parts were mixed and enough of an aromatic tertiary amine to react with the initiator in Part A and cause curing. The proportions of the free-radical initiation system were adjusted so that cure would occur substantially later than the light curing. Results are as follows:

TABLE 2

| Sample | Depth of Cure | Depth after one hour |
|---|---|---|
| Formula A + Formula C | 4.8 | 10.1 |
| Formula B + Formula C | 1.4 | 9.5 |

The above examples illustrate the fact that when cured through a porcelain veneer, the light-cured cement had marginal cure depth, but the dual-cured cement showed greatly increased cure depth one hour later.

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of devices would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A method of bonding porcelain veneers or restorations to a tooth comprising:
applying a resin comprising an opaquing agent to the surface of a tooth, and
applying a veneer or restoration to the resin.

2. The method of claim 1, wherein the resin is light curable.

3. The method of claim 1, wherein the opaquing agent is titanium dioxide.

4. The method of claim 1, wherein the resin comprises a free-radical initiator.

5. The method of claim 4, wherein the free-radical initiator is benzoyl peroxide.

6. The method of claim 1, wherein hard tissue has not been removed from the tooth.

7. The method of claim 1, wherein the composite resin cement is a dual-cure composite resin.

8. A dual-cure composite resin cement comprising an opaquing agent.

9. The composite resin cement of claim 8, wherein the composite resin cement is light curable.

10. The composite resin cement of claim 8, wherein the composite resin cement comprises a free-radical initiator.

11. The composite resin cement of claim 8, wherein the opaquing agent is titanium dioxide.

12. The composite resin cement of claim 11, wherein the composite resin cement is light curable.

13. The composite resin cement of claim 11, wherein the composite resin cement comprises a free-radical initiator.

14. The composite resin cement of claim 8, wherein the composite resin cement is of a shade that matches a shade on the Vita™shade guide.

15. A method of bonding porcelain veneers or restorations to a tooth comprising:
applying a composite resin cement to the enamel of a tooth, and
applying a veneer or restoration to the resin,
wherein the composite resin cement comprises an opaquing agent.

16. The method of claim 15, wherein the opaquing agent is titanium dioxide.

17. The method of claim 16, wherein the composite resin cement is light curable.

18. The method of claim 16, wherein the composite resin cement comprises a free-radical initiator.

19. A method of bonding porcelain veneers or restorations to a tooth comprising:
applying a composite resin cement to the enamel of a tooth, and
applying a veneer or restoration to the resin,
wherein the composite resin cement is a dual-cured cement and comprises an opaquing agent.

20. The method of claim 19, wherein the opaquing agent is titanium dioxide.
